(19) United States
(12) Patent Application Publication
(10) Pub. No.: US 2025/0292228 A1
(43) Pub. Date: Sep. 18, 2025

(54) SYSTEMS AND METHODS FOR LOCATION BASED TRANSACTION DISPLAY AND EXECUTION

(71) Applicant: WELLS FARGO BANK, N.A., San Francisco, CA (US)

(72) Inventors: Karthikeyan Rajagopal, San Francisco, CA (US); Rungson Samroengraja, San Francisco, CA (US)

(73) Assignee: WELLS FARGO BANK, N.A., San Francisco, CA (US)

(21) Appl. No.: 18/603,908

(22) Filed: Mar. 13, 2024

(51) Int. Cl. G06Q 20/32; G06F 3/0482; G06Q 30/0601

(52) U.S. Cl. CPC G06Q 20/3224; G06F 3/0482; G06Q 30/0631

(57) ABSTRACT

A system includes a processing circuit configured to generate location data relating to a person associated with transaction data where the location data is associated with a location, receive the transaction data relating to the person where the transaction data corresponds to historical transactions of the person, generate merchant match data based on the location data and the transaction data where the merchant match data indicates a merchant within a distance threshold of the location and being associated with at least one of the historical transactions, and generate and provide a notification interface based on the merchant match data to a graphical user interface of a user device where the notification interface comprises an interactive element associated with the at least one of the historical transactions related to the merchant.

### TECHNICAL FIELD

The present disclosure relates generally to tracking the location of a personal device and providing transaction information for one or more merchants to the personal device based on the same.

### BACKGROUND

When in proximity to or entering a premises of a merchant, people typically have difficulty accessing or analyzing their transaction history with the merchant.

### SUMMARY

Some arrangements relate to a system. In some arrangements, the system includes a processing circuit. In some arrangements, the processing circuit includes memory and one or more processors. In some arrangements, the processing circuit is configured to generate location data relating to a person associated with transaction data where the location data is associated with a location. In some arrangements, the processing circuit is configured to receive the transaction data relating to the person where the transaction data corresponds to historical transactions of the person. In some arrangements, the processing circuit is configured to generate merchant match data based on the location data and the transaction data where the merchant match data indicates a merchant within a distance threshold of the location and being associated with at least one of the historical transactions. In some arrangements, the processing circuit is configured to generate and provide, to a graphical user interface (GUI) of a user device, a notification interface based on the merchant match data where the notification interface comprises an interactive element associated with the at least one of the historical transactions related to the merchant.

Some arrangements relate to a method. In some arrangements, the method includes generating, by a processing circuit, location data relating to a person associated with transaction data where the location data is associated with a location. In some arrangements, the method includes receiving the transaction data relating to the person where the transaction data corresponds to historical transactions of the person. In some arrangements, the method includes generating merchant match data based on the location data and the transaction data where the merchant match data indicates a merchant within a distance threshold of the location and being associated with at least one of the historical transactions. In some arrangements, the method includes generating and providing, to a graphical user interface (GUI) of a user device, a notification interface based on the merchant match data where the notification interface comprises an interactive element associated with the at least one of the historical transactions related to the merchant.

Some arrangements relate to a computer-readable storage medium (CRM) having instructions stored thereon that, when executed by a processing circuit, cause the processing circuit to perform operations. In some arrangements, the operations include generating, by the one or more processing circuits, location data relating to a person associated with transaction data where the location data associated with a location. In some arrangements, the operations include receiving the transaction data relating to the person where the transaction data corresponds to historical transactions of the person. In some arrangements, the operations include generating merchant match data based on the location data and the transaction data where the merchant match data indicates a merchant within a distance threshold of the location and being associated with at least one of the historical transactions. In some arrangements, the operations include generating and providing, to a graphical user interface (GUI) of a user device, a notification interface based on the merchant match data where the notification interface comprises an interactive element associated with the at least one of the historical transactions related to the merchant.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing environment including a merchant match system, according to example embodiments.

FIG. 2 is a block diagram illustrating an example computing system suitable for use in the example embodiments described herein.

FIG. 3 is a flow diagram of a method for displaying merchant match data, according to example embodiments.

FIG. 4 is an illustration of a configuration of a user interface generated by the merchant match system of FIG. 1, according to example embodiments.

FIG. 5 is an illustration of an additional configuration of a user interface generated by the merchant match system of FIG. 1, according to example embodiments.

FIG. 6 is an illustration of an additional configuration of a user interface generated by the merchant match system of FIG. 1, according to example embodiments.

FIG. 7 is an illustration of an additional configuration of a user interface generated by the merchant match system of FIG. 1, according to example embodiments.

FIG. 8 is an illustration of an additional configuration of a user interface generated by the merchant match system of FIG. 1, according to example embodiments.

FIG. 9 is an illustration of an additional configuration of a user interface generated by the merchant match system of FIG. 1, according to example embodiments.

FIG. 10 is an illustration of an additional configuration of a user interface generated by the merchant match system of FIG. 1, according to example embodiments.

FIG. 11 is an illustration of an additional configuration of a user interface generated by the merchant match system of FIG. 1, according to example embodiments.

### DETAILED DESCRIPTION

Referring generally to the figures, systems and methods for displaying historical transaction information of a person associated with a merchant that is within a distance threshold of a merchant location are described herein according to various embodiments. In some instances, the systems and methods provide notification interfaces that display historical transactions of the person related to the merchant within the distance threshold of the location, such that a user is made aware of the historical transactions of the person related to the merchant within the distance threshold. Additionally, in some instances, the systems and methods described herein include displaying a list of items included in the historical transactions related to the merchant or to a related merchant (e.g., similar type of merchant, another franchise location of the merchant, a merchant selling similar goods, etc.).

In some instances, the systems and methods display the historical transactions of the person in response to determining that a user device of the user is within the distance threshold of the merchant. For example, in some instances, the systems and methods herein may use data associated with the user device to determine that the user device is within the distance threshold of the merchant and provide the historical transactions of the person associated with the merchant in response. The systems and methods described herein may provide a first interactive element that is related to a first merchant within the distance threshold of the user and a second interactive element that is related to a second merchant within the distance threshold, such that the user May consider each of the merchants related to the historical transactions of the person that are within the distance threshold.

In some instances, the systems and methods include receiving a selection of a location interactive element associated with a location from the user of the user device and display historical transactions of the person associated with merchants within the distance threshold of the location associated with the location marker. For example, the systems and methods may provide a location interface to the user of the user device that allows the user to select a location interactive element associated with a location. The selection of the location interactive element associated with the location may cause the system to provide the historical transactions of the person related to the merchants within the distance threshold of the location associated with the location interactive element.

In some instances, the system enables communications with merchant computing systems associated with one or more merchants within the distance threshold of the location to provide offers to the user associated with at least one of the historical transactions of the person related to the one or more merchants. In some instances, the system provides recommendations to the user based on the offers from the merchant and the historical transactions of the person related to the merchant. While reference is made to a “person,” it will be appreciated that the system may take into account information associated with other people associated with the person, such as the transaction history of other people of the same household as the person.

The systems and methods described herein provide a variety of improvements over conventional computing systems. For example, conventional computing systems have not been configured to provide notification interfaces associated with historical transactions of a person related to a merchant based on the merchant being within a distance threshold of a location related to the person. As such, a person may have difficulty determining which of their historical transactions are associated with a merchant when the person enters the proximity of the merchant or enters the premises of the merchant. Further, conventional computing systems have never been configured to determine the historical transactions of the person that are associated with a merchant that is within a distance threshold of a location selected by the person using a location interface when the person is not in proximity to the location.

The systems and methods described herein solve these issues by providing users with notification interfaces that include historical transactions of a person that are related to merchants that are close (e.g., within a threshold distance) to a location related to the person, such that the user may easily determine the historical transactions of the person relating to one or more of the merchants within a proximity to the location. Reducing a number of the historical transactions of the person displayed to the user by displaying only the historical transactions related to the merchants within the distance threshold of the location reduces the computing power necessary to display entire transaction histories and ease the process of the user searching for a specific historical transaction of the person. In some instances, the user may be provided with a list of items included in one of the historical transactions of the person related to the merchant, such that the user may easily determine what items were included in the historical transaction. In some instances, the system filters historical transactions made by the person at the merchant based on determining a purpose for the visit to the merchant by the user, such that only prior transactions made by the person relating to a certain type of good, amount of purchase, or other purchase characteristic are displayed on the user device. In some instances, the location may be determined based on determining that the user device of the user is within the distance threshold of the merchant. In other instances, the location may be associated with a location interactive element selected by the user through a location interface provided to the user device. Additionally, offers received from a merchant computing system of the merchant relating to the historical transactions of the person may be provided to the user, allowing the user to receive targeted offers based on the historical transactions of the person.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

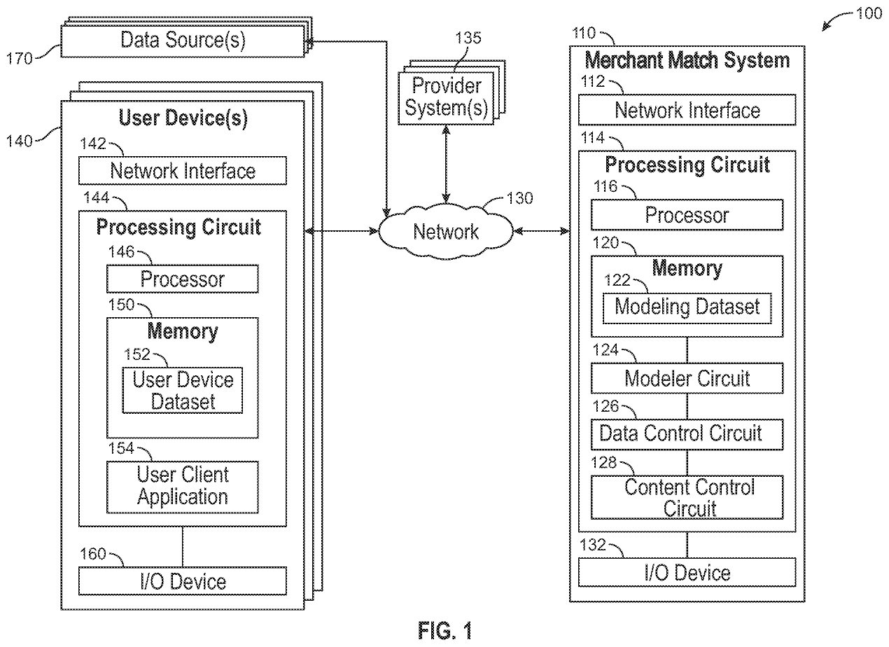

Referring to FIG. 1, a block diagram of a computing environment 100 including a merchant match system 110 is shown, according to potential embodiments. The merchant match system 110 can be associated with a provider, such as a service provider, bank, or financial institution (FI). The computing environment 100 further includes one or more user devices (e.g., user device 140), one or more data sources (e.g., data source 170), and one or more provider systems (e.g., the provider system 135). In some embodiments, the merchant match system 110, user device 140, and data source 170 are communicatively coupled. The various components of the computing environment are in communication with each other and are connected by a network 130.

Although the various systems and devices are shown in FIG. 1 as being singular, it will be understood that, in some instances, the computing environment 100 includes one or multiple of any of the various illustrated systems and/or devices, as desired for a given application. Similarly, while the following descriptions of the various systems and devices are largely provided in terms of single systems or devices, it will be appreciated that these descriptions are similarly applicable to any additional corresponding systems and/or devices (e.g., additional of the provider systems 135, additional of the user devices 140, and so on).

The merchant match system 110 may be operated by a provider, such as an entity, a consultant, a retailer, a service provider, and so on. The merchant match system 110 includes a network interface 112 that connects the merchant match system 110 to the network 130. The network interface 112 facilitates secure communications between the merchant match system 110 and various other components of the computing environment 100. The network interface 112 also facilitates communication with other entities (e.g., provider systems 135, etc.), such as other banks, healthcare systems, and so on. Further, in some arrangements, the network interface 112 includes cryptography capabilities to establish a secure or relatively secure communication session in which data communicated over the session is encrypted.

The processing circuit 114 includes a processor 116, a memory 120, a modeler circuit 124, a data control circuit 126, and a content control circuit 128. In other embodiments, the processing circuit 114 may contain more or less components than are shown in FIG. 1. The processor 116 may be implemented as one or more application specific integrated circuits (ASICs), field programmable gate arrays (FPGAs), a group of processing components, or other suitable electronic processing components. The memory 120 may be a device for storing data and/or computer code. The memory 120 may store data associated with a variety of application programs ran by the merchant match system 110. One such application may be to provide data to the modeler circuit 124, data control circuit 126, and content control circuit 128. The memory 120 can store a variety of data related to the modeler circuit 124 in a modeling dataset 122, which may be used by the modeler circuit 124 as discussed herein.

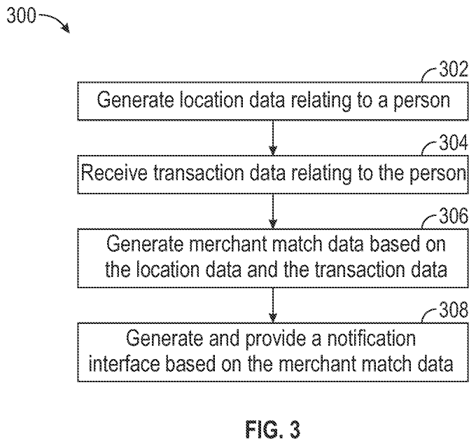

The modeler circuit 124 is structured or configured to perform a variety of the functionalities described herein. As will be described in detail below, with regard to FIG. 3, the modeler circuit 124 is configured to provide merchant match data to a user that is indicative of historical transactions of a person related to a merchant within a distance threshold of a location related to the person. The historical transactions can include one or more previous transactions made by the user or a person associated with the user (e.g., a family member or household member of the user). In some instances, the modeler circuit 124 is configured to provide merchant match data to the user that is indicative of historical transactions related to a merchant that is within a distance threshold of a location of the user. In other embodiments, the modeler circuit 124 is configured to provide merchant match data to the user that is indicative of historical transactions related to a merchant that is within a distance threshold of a location provided by the user.

As will similarly be described below, in some instances, the modeler circuit 124 is further configured to communicate with a merchant computing systems associated with the merchant within the distance threshold of the location in order to provide offers associated with the person to the user. In some instances, the modeler circuit 124 is further configured to model offers received from the merchant computing system associated with the merchant within the distance threshold of the location in order to generate recommendation data corresponding with at least one of the offers based on the historical transactions of the person. In some instances, the modeler circuit 124 is further configured to provide first of the historical transactions associated with a first merchant within the distance threshold of the location and second of the historical transactions associated with a second merchant within the distance threshold of the location.

The data control circuit 126 is configured to fuse data, including operations to generate various data structures stored in the memory 120 and used by the various circuits described herein. The data control circuit 126 can also be configured to receive data from multiple sources (e.g., the data sources 170, the provider systems 135, the user devices 140, etc.) and aggregate the data into various data structures stored in the memory 120.

The content control circuit 128 is configured to generate content for displaying to users. The content can be selected from various resources (e.g., a request for transactions associated with a retailer from the data control circuit 126). The content control circuit 128 can also be structured to provide content (e.g., via a graphical user interface (GUI)) to the user device 140 over the network 130, for display. The content can also include actionable items (e.g., interactive elements) that the user may select or otherwise manipulate. The content can be selected from various resources (e.g., from the data control circuit 126, from the memory 120, etc.).

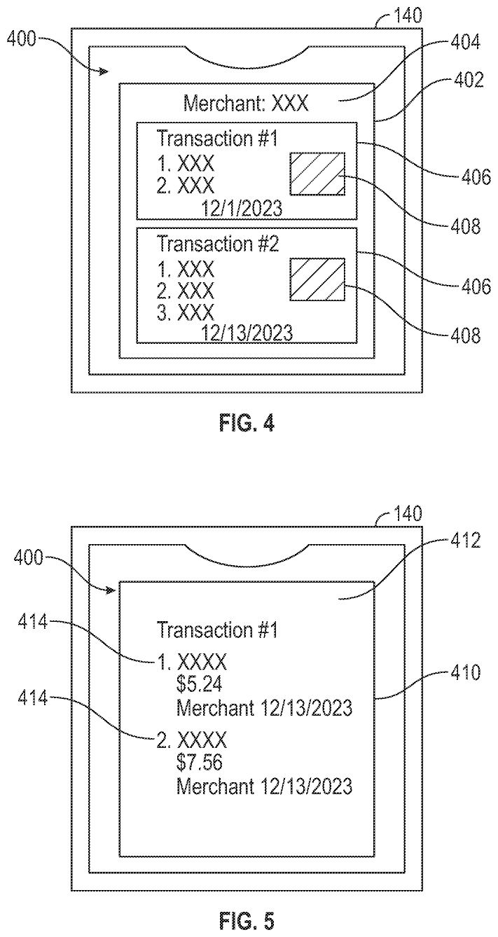

The content generated by the content control circuit 128 can include customized dashboards, such as those described in detail below, with reference to FIGS. 4-10. The content control circuit 128 can generate customized user-interactive dashboards for one or more entities, such as the user device 140, based on data received from the user device 140, data source 170, and/or any other computing device described therein. The generated dashboards can include various data (e.g., data stored in the content control circuit 128 and/or modeling dataset 122) associated with one or more transactions such as valuations, photographs or videos, descriptions, and/or others. In certain embodiments, the merchant match system 110 includes an application programming interface (API) and/or a software development kit (SDK) that facilitate the integration of other applications with the merchant match system 110. For example, the merchant match system 110 is configured to utilize the functionality of the user device 140 interacting through an API.

The content control circuit 128 can generate an interface corresponding to the merchant match data (e.g., generated by the modeler circuit 124). In some instances, the interface may include interactive elements illustrating the historical transactions of a person associated with merchants that are located within a predetermined distance of the person. For example, the interface may include first interactive elements corresponding to first transactions associated with a first merchant within the predetermined distance and second interactive elements corresponding to second transactions associated with a second merchant within the predetermined distance. In some instances, the interface may include a list of items included in one of the historical transactions (e.g., an itemized list of the historical transactions, a list of goods or services included in the historical transaction, etc.). For example, the interface may include a list of a first offering, a second offering, and a third offering purchased by the person during one of the historical transactions.

In some instances, the content control circuit 128 can generate a location interface corresponding to a plurality of potential locations. The location interface may include a plurality of markers corresponding with each of the potential locations. For example, the location interface may include a map with potential locations indicated with markers. The user may select one of the markers in order to indicate a location. In some instances, the content control circuit 128 can generate an offer interface corresponding to an offer. For example, a merchant may create an offer associated with a person and the offer interface may display the offer to the person. In some instances, the content control circuit 128 can generate a recommendation interface corresponding to an offer for a person based on historical transactions of the person. For example, the recommendation interface may include an offer interactive element associated with an offer that was included in a historical transaction. As another example, the recommendation interface may include an offer interactive element associated with an offer that relates to a historical offer included in a historical transaction.

The input/output device 132 is structured to receive communications from and provide communications to users associated with the merchant match system 110. The input/output device 132 can be structured to exchange data, communications, instructions, etc. with an input/output component of the merchant match system 110 (e.g., a mouse, a monitor, a keyboard, etc.). As such, the input/output device 132 may provide an interface for the user to interact with various applications stored on the merchant match system 110.

The user device 140 is owned, operated, controlled, and/or otherwise associated with a person (e.g., a person looking to acquire a real estate property, etc.). In some embodiments, the user device 140 may be or may include, for example, a desktop or laptop computer (e.g., a tablet computer), a smartphone, a wearable device (e.g., a smartwatch), a personal digital assistant, and/or any other suitable computing device. The user devices 140 may each include a network interface 142, a processing circuit 144, and an input/output device 160. The network interface 142, the processing circuit 144, and the input/output device 160 may be structured and function substantially similar to and include the same or similar components as the network interface 112, the processing circuit 114, and the input/output device 132 described above, with reference to the merchant match system 110. Therefore, it should be understood that the description of the network interface 112, the processing circuit 114, and the input/output device 132 of the merchant match system 110 provided above may be similarly applied to the network interface 142, the processing circuit 144, and the input/output device 160 of each of the user devices 140. The network interface 142 may similarly facilitate secure communications between the user device 140 and various other components of the computing environment 100. The processing circuit 144 similarly includes a memory 150 and a processor 146. The memory 150 and the processor 146 are substantially similar to the memory 120 and the processor 116 described above. Accordingly, the user devices 140 are similarly configured to run a variety of application programs and store associated data in a database of the memory 150. The variety of application programs and associated data may be stored as user device dataset 152.

Additionally, processing circuit 144 of each of the user devices 140 may each store, in the memory 150, and execute (“run”) user client applications 154, such as an Internet browser presenting websites and/or applications provided or authorized by entities implementing or administering any of the computing systems in computing environment 100 to enable the user to perform or otherwise interact with various methods and operations described herein. For example, in some instances, the user client applications 154 comprise a provider client application (e.g., a financial institution banking application) provided by and at least partly supported by the merchant match system 110 and configured to enable various functionality described herein. In some instances, the user client applications 154 comprise a provider client application provided by and at least partly supported by the provider system 135 and configured to enable various functionality described herein.

In some instances, the user client application 154 is additionally coupled to various components within the computing environment 100 (e.g., the merchant match system 110, the provider system 135) via one or more application programming interfaces (APIs) and/or software development kits (SDKs) to integrate one or more features or services provided by the various components to enable the various methods and operations described herein. For example, in some instances, a provider client application provided to the user device 140 by the merchant match system 110 implements various functionality of the provider system 135 via one or more APIs and/or SDKs to allow for various functionality and/or information provided and/or stored by the provider system 135 to be utilized or otherwise implemented within the context of the provider client application.

Additionally, the user client application 154 is configured to output information to a display of user device 140 regarding information received from the merchant match system 110. For example, the user client application 154 is configured to communicate with a user interface to show graphics regarding content associated with transactions such as a photograph, a merchant, a video, a valuation, or a description. Further, a user response to a display of user device 140 regarding information from the merchant match system 110 can send a message, task, or instruction to the merchant match system 110 via the network 130 that allows for the modeling dataset 122, modeler circuit 124, data control circuit 126, and/or content control circuit 128 to be perform an update.

The data sources 170 can provide data to the merchant match system 110 and/or user device 140. In some arrangements, the data sources 170 can be structured to collect data from other devices on network 130 (e.g., user devices 140 and/or other third-party devices) and relay the collected data to the merchant match system 110 and/or user device 140. In some embodiments, the merchant match system 110 may request data associated with specific data stored in the data source (e.g., data sources 170). For example, in some arrangements, the data sources 170 can support a search or discovery engine for Internet-connected devices. The search or discover engine may provide data from other providers that, when used to update merchant data associated with a merchant, will cause an update to the merchant match data for a person (e.g., merchant match data generated by the modeler circuit 124 based on location data and transaction data of a person, etc.). For example, the search or discover engine may provide data from other providers indicating that a bookstore within a distance threshold of a person has closed and transaction data relating to the person may include historical transactions with the bookstore. The bookstore may be removed from merchant match data associated with the person since the bookstore is no longer open. As another example, the search or discovery engine may provide data from other providers indicating an offer available from a merchant. The offer may be related to historical transactions of a person related to the merchant. For example, if a person has historically purchased a washer from the merchant, the search or discovery engine may provide data from a merchant computing system associated with the merchant indicating an offer for a dryer available from the merchant.

With reference again to FIG. 1, the provider system 135 is controlled by, managed by, owned by, and/or otherwise associated with a provider, such as a bank, a credit union, an appraiser, a health care institution, a governmental institution, or other institutions (e.g., credit card companies, financial institutions (FI), insurance institutions, etc.). In some embodiment, the provider system may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. In some instances, the provider system 135 includes and/or has various other devices communicably coupled thereto, such as, for example, desktop or laptop computers (e.g., tablet computers), smartphones, wearable devices (e.g., smartwatches), and/or other suitable devices.

The provider system 135 may also store various individual information, location data, transaction data, merchant match data, offer data, recommendation data, and various other information. In some instances, the provider system 135 is configured to retrieve and transmit various individual data stored within the provider system 135 to various components within the computing environment 100 to enable the various methods, functions, and processes described herein.

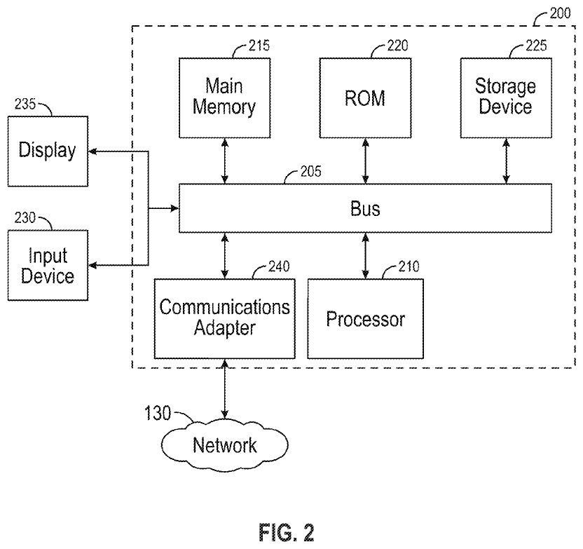

Referring now to FIG. 2, a depiction of a computing system 200 is shown. The computing system 200 can be used, for example, to implement the computing environment 100, the merchant match system 110, provider systems 135, user devices 140, data sources 170, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk, or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In some arrangements, the display 235 of the input device 230 has a touch screen. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with the network 130 and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory (e.g., a non-transitory computer-readable storage medium, etc.).

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, or virtual server. In various arrangements, computing system 200 may share physical storage, hardware, and other resources with other virtual machines. In some arrangements, virtual resources of the network 130 (e.g., network 130 of FIG. 1) may include cloud computing resources such that a virtual resource may rely on distributed processing across more than one physical processor, distributed memory, etc.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring now to FIG. 3, a flowchart for a method 300 of providing a notification corresponding to historical transactions of a person relating to a merchant based on the merchant being within a threshold distance of a location related to the person, according to some instances. The merchant match system 110 can be configured to perform the method 300. Further, any computing device described herein can be configured to perform the method 300. The GUI of the method 300 may be provided by and/or accessible by the user client application 154 and the content control circuit 128, for example. The method 300 may be performed by the merchant match system 110 or the user device 140, described above pertaining to FIGS. 1 & 2. In some instances, the method 300 begins in response to receiving, by a user device (e.g., user device 140) and/or through a user client application (e.g., user client application 154), data from a dataset (e.g., user device dataset 152). The data can include transaction data including a transaction of the person or location data relating to a location relating to the person. For example, in some instances, a user may initiate a merchant match analysis through a user device (e.g., the user device 140) by uploading transaction data relating to transactions of a person. In some instances, the method 300 begins when the merchant match system 110 receives data via the network 130.

The method 300 begins with the processing circuit (e.g., the merchant match system 110) generating location data relating to a person, at step 302. The location data may include a location (e.g., a position, a place, etc.). In some instances, the processing circuit may be configured to generate the location data based on device data received from the user device. For example, the user device of the user may provide the processing circuit with a device location of the user device based on a location system of the user device (e.g., a satellite location system, a GPS system, etc.) and the processing circuit may generate the location data based on the device location. In some instances, the processing circuit is configured to generate the location data using near field communication technology or beacons (e.g., Bluetooth beacons, etc.) to determine the location of the user device of the user. In some instances, the processing circuit is configured to determine the location of the user device relative to the merchant location of the merchant. For example, a merchant may install a Bluetooth beacon at a location configured to ping user devices. The processing circuit may be configured to generate location data including the location in response to receiving an indication from a user device that the user device has been pinged by the Bluetooth beacon of the merchant. In various instances, the location data is generated based the user device scanning (e.g., photographing with a camera, etc.) a QR code of a merchant. For example, a merchant may display a QR code at a location and the processing circuit may be configured to generate the location data including the location in response to receiving an indication that a user device has scanned the QR code.

In some instances, the processing circuit may be configured to generate the location data based on merchant data received from a merchant system of one of the merchants. In various embodiments, the merchant system may utilize near field communication technologies, beacons (e.g., Bluetooth beacons, etc.), or QR codes. For example, a merchant may install a merchant system including a Bluetooth beacon at a location configured to identify a user device when the user device is within a distance threshold of the Bluetooth beacon (e.g., within a range of the Bluetooth beacon, etc.). The processing circuit may be configured to generate the location data including the location in response to receiving an indication from the merchant system that a user device has been identified by the merchant system.

In some instances, the processing circuit may be configured to generate the location data based on the device location being within a distance threshold (e.g., within a distance of, etc.) of a merchant (e.g., a vendor, a storefront, etc.) that is related to historical transactions (e.g., transactions that have previously occurred, etc.) of the person. For example, the processing circuit may track the device location of the user device in order to determine if the device location is within the distance threshold of a merchant related to historical transactions of the person. Once the device location moves within the distance threshold of the merchant related to the historical transactions of the person, the processing circuit may generate the location data related to the person in order to begin the method 300. In some instances, the distance threshold is configured to be the premises of one of the merchants. For example, the distance threshold for one of the merchants may be all locations within a building operated by the one of the merchants.

In some instances, prior to generating the location data, the processing circuit is configured to provide a location interface corresponding to a plurality of potential locations to the user device of the user. The location interface includes a plurality of location interactive elements, each corresponding to a potential location. In response to a selection of one of the location interactive elements from the user device (e.g., by the user, etc.), the processing circuit is configured to generate the location data to include the location of the potential location corresponding to the one of the locations. For example, the processing circuit may provide a location interface including a map. The map may include location interactive elements corresponding to potential location such as street addresses, roads, intersections, buildings, etc. The user of the user device may select one of the location interactive elements included in the map (e.g., by dropping a pin on the map, etc.) in order to begin the method 300 by generating the location data with the location of the location data being the potential location corresponding to one of the location interactive elements that was selected by the user.

In some instances, at least one of the location interactive elements of the location interface may correspond with one of the merchants, such that the location generated by the processing circuit may be the same as the merchant location of the one of the merchants in response to the selection of the at least one of the location interactive elements of the location interface. By including the merchant locations as potential locations for the merchant match analysis, the user be able to be provided with the historical transactions associated with the merchant of the merchant location that was selected or the historical transactions that occurred during a shopping trip to multiple merchants around the merchant of the merchant location that was selected. For example, a person may have gone on a shopping trip that included a known merchant that the person can recall and an unknown merchant that the person cannot recall. By selecting a location interactive element associated with the known merchant, the merchant match analysis may present the person with the unknown merchant and the historical transactions related to the unknown merchant based on a proximity of the known merchant and the unknown merchant, such that the person can identify the unknown merchant and the historical transactions associated with the unknown merchant.

Once the processing circuit has generated the location data relating to the person, the processing circuit is configured to receive transaction data relating to the person, at step 304. The transaction data may be received from the user device of the user or from other data sources. The transaction data may relate to a transaction of the person and may include names of the transaction, valuations of the transaction, images associated with the transaction, merchants related to the transaction, a list of items included in the transaction, or other information relating to the transaction. In some instances, the transaction data may correspond to historical transactions of the person (e.g., a transaction history of the person, etc.). For example, the transaction data may include a transaction made by the person during a previous month, a previous year, or a previous decade.

In some instances, the location data and the transaction data may include all of the information required to determine merchant match data or the modeler circuit 124 may need to receive additional location data or transaction data from a different source (e.g., the provider system 135, the data source 170, etc. For example, a user may request that a merchant match analysis be performed through the user interface of the user device 140 and may also upload transaction data relating to the historical transactions of the person. The transaction data uploaded by the user may include all of the transaction data required to perform the merchant match analysis or the modeler circuit may need to receive additional data from a different source (e.g., the provider system 135, the data source 170, etc.). For example, the transaction data received from the user may not include a merchant location of the merchant related to the historical transactions of the transaction data. The processing circuit may receive data corresponding to the merchant location of the merchant from the different source in order to perform the merchant match analysis. In some instances, the processing circuit may send requests for the additional location data or transaction data from the different source. For example, the processing circuit may send a request for additional location data from the data source 170 that is needed to determine the merchant match data.

Once the processing circuit has received the transaction data of the person, the processing circuit is configured to model the location data with the transaction data to generate merchant match data, at step 306. The merchant match data may correspond to a merchant within a distance threshold of the location included in the location data. In some instances, at least one of the historical transactions included in the transaction data is related to the merchant of the merchant match data. For example, the transaction data may include multiple transactions relating to multiple merchants and merchant locations associated with the merchants. The processing circuit can model the location data with the transaction data to generate merchant match data that includes a merchant with a merchant location that is within a distance threshold of the location included in the location data that is related to at least one of the historical transactions included in the transaction data.

In some instances, the distance threshold may vary between different of the merchants. For example, a first distance threshold may correspond to a pharmacy and a second distance threshold that is larger than the first distance threshold may correspond to a hardware store. In some instances, the distance threshold for each of the merchants may be determined based on a category of the merchant. For example, a first distance threshold of the merchants belonging to a restaurant category may be less than a second distance threshold of the merchants belonging to a big box store category. In some instances, differences between the distance thresholds of the merchants may depend on a density of the merchant, a density of the category of the merchant, a typically distance traveled by an average person to visit the category of the merchant, etc.

In some instances, the relationship between the merchant and the historical transaction is that the historical transaction was performed with the merchant at the merchant location. For example, the person may have purchased an item from a storefront of the merchant. In some instances, the relationship between the merchant and the historical transaction is that the historical transaction was performed with the merchant at a location other than the merchant location. For example, the person may have purchased an item from a website of the merchant or another merchant location of the merchant (e.g., from a different branch location of the merchant, etc.). In various instances, the relationship between the merchant and the historical transaction is that the historical transaction was performed at another merchant that belongs to a category of merchants that is the same as the merchant. For example, the person may have purchased medicine at a first pharmacy that is not within the distance threshold, so the merchant match data may correspond to a second pharmacy with a merchant location that is within the distance threshold.

In some instances, the processing circuit may determine that a first merchant takes precedence over a second merchant while generating the merchant match data and generate the merchant match data to correspond with the first merchant. The processing circuit may determine that the first merchant takes precedence over the second merchant based on the location of the location data being closer to the merchant location of the first merchant than the merchant location of the second merchant, a first frequency of the historical transactions related to the first merchant being greater than a second frequency of the historical transactions related to the second merchant, a first number of the historical transactions related to the first merchant being greater than a second number of the historical transactions related to the second merchant, a first transaction of the historical transactions related to the first merchant occurring more recently than a second transaction of the historical transactions related to the second merchant, etc. For example, the historical transactions of the person may include four transactions with a bookstore and five transactions with a restaurant. The processing circuit may determine that the restaurant takes precedence over the bookstore due to the quantity of the historical transactions relating to the restaurant being higher than the quantity of the historical transactions relating to the bookstore and may accordingly correspond the merchant match data with the restaurant.

In some instances, the merchant match data generated by the processing circuit corresponds to a first merchant within the distance threshold of the location and to a second merchant within the distance threshold of the location and a first of the historical transactions is related to the first merchant and a second of the historical transactions is related to the second merchant. For example, the merchant match data may correspond to a hardware store based on the hardware store being within a mile of the location of the location data and the person having purchased a lawnmower at the hardware store a month prior and the merchant match data may correspond to a coffee shop based on the coffee shop being within a mile of the location of the location data and the person having purchased a coffee at the coffee shop an hour prior. In various instances, the merchant match data generated by the processing circuit corresponds to additional merchants (e.g., a third merchant within the distance threshold of the location, a fourth merchant within the distance threshold of the location, etc.) and additional of the historical transactions are related to the additional merchants (e.g., a third of the historical transactions is related to the third merchant, a fourth of the historical transactions is related to the fourth merchant, etc.).

In some instances, the process of modeling can include using techniques such as machine learning, statistical analysis, and pattern recognition to establish relationships between data and parameters and generate resulting data based on those relationships. In some instances, modeling can begin with the selection of an appropriate model based on the data and the parameters. It should be understood that the term modeling herein encompasses a wide range of techniques and approaches aimed at understanding relationships within data. This could include anything from statistical methods and rule-based systems to machine learning algorithms, depending on the nature of the data. Thus, modeling involves selecting techniques based on the specific characteristics of the data, ensuring that the chosen method or methods accurately captures relationships.

In some instances, the model parameters can be trained and optimized using the cleaned, classified, and linked data and parameters. This training process can include using algorithms to adjust the model parameters such that the error between the model's predictions and the actual outcomes is minimized. The modeling process can also include feature engineering, which is the process of creating new features or modifying existing ones to improve the model's power. For example, instead of generating merchant match data corresponding to a grocery store, a feature that ignores the transaction data associated with grocery stores might result in a more efficient model due to the fact that transactions at grocery stores may vary wildly depending on what the person is planning on cooking.

Once one or more models or techniques are trained and/or optimized, the processing circuits can use the model to generate resultant data. The resultant data could be a mathematical representation, a decision tree, a set of rules, or any other structure that captures the relationships between different data points. Moreover, the modeling process can include various safeguards to ensure privacy and security of user data (e.g., anonymizing the data).

In some instances, the processing circuits can use rule-based systems to model the data and the parameters. Rule-based systems can be where predefined rules are created by the processing circuits (or domain experts) to infer outcomes based on given conditions. For example, if the location of the location data is within a state and a merchant does not have any merchant locations within the state, a rule may state that any historical transactions relating to the merchant should be ignored while the location of the location data is within the state. This rule can be applied to the process to limit the process to modeling the location data with transaction data that does not relate to the merchant.

Once the processing circuit has generated the merchant match data corresponding to the merchant, the processing circuit may generate and provide a notification interface corresponding to the merchant match data, at step 308. The processing circuit may provide the notification interface to a graphical user interface (GUI) of a user device (e.g., the user client application 154 of the user device 140). The notification interface may include interactive elements (e.g., text, videos, images, buttons, etc.) associated with the at least one of the historical transactions related to the merchant. For example, the notification interface may include an interactive element that is an image relating to the historical transaction, a date of the historical transaction, an amount spent during the historical transaction, a copy of a receipt of the historical transaction (e.g., a digital copy of the receipt of the historical transaction, etc.), etc. In some instances, the interactive elements may include a list of items included in the historical transaction related to the merchant. For example, the interactive element may include a list of each of the items that were purchased by the person during their last trip to the merchant. In some instances, the list of each of the items may include an amount that the person exchanged for the item, an image of the item, or other interactive elements associated with additional information related to the item. In various instances, the notification interface includes interactive elements associated with each of the historical transactions related to one of the merchants within the distance threshold of the location.

In some instances, the processing circuit may be configured to provide the user device of the user with a notification when the user device is within the distance threshold of the merchant related to historical transactions of the person. For example, the processing circuit may determine that a person has completed historical transactions with a merchant within a distance threshold of a location of a user device of a user. In response to determining that the user device is within the distance threshold of the merchant, the processing circuit may provide a notification to the user device such that the user is notified that the user device is within the distance threshold of the merchant. In some instances, the notification may be a visual notification (e.g., a notification on a display of the user device, etc.), an audio notification (e.g., a noise through speakers of the user device, etc.), a tactile notification (e.g., a vibration of the user device, etc.), or another form of notification. In some instances, the processing circuit is configured to provide the user device with the notification when the user device is within the premises of the merchant. For example, the distance threshold may be limited to only include the premises of the merchant such that the notification is provided to the user device when the user device is within the distance threshold and within the premises of the merchant.

In some instances, the interactive elements of the notification interface may be actionable items (e.g., buttons, sliders, etc.). The processing circuit may be configured to generate and provide additional information related to the historical transaction or the items of the historical transaction to the user device when the user selects the actionable item on the user device. For example, the notification interface may include a button associated with one of the historical transactions and the processing circuit may be configured to generate and provide a list of items included in the one of the historical transactions to the GUI of the user device in response to receiving a selection of the button from the user device. As another example, the notification interface may include a scroll bar associated with the historical transactions related to the merchant, the notification interface may only display a first selection of the historical transactions, and the processing circuit may be configured to update the notification interface to display interactive elements corresponding to a second selection of the historical transactions not included in the first selection in response to receive a user input relating to the scroll bar from the user device.

In some instances, when the merchant match data corresponds to a first merchant and a second merchant, the notification interface includes a first interactive element associated with a first of the historical transactions related to the first merchant and a second interactive element associated with a second of the historical transactions related to the second merchant. For example, when the merchant data corresponds to a bookstore and a barber shop, the notification interface may include a first interactive element associated with a purchase of a book from the bookstore and a second interactive element associated with a purchase of a haircut from the barbershop. In some instances, the notification interface may also include a first actionable item associated with the first of the historical transactions and a second actionable item associated with the second of the historical transactions. The processing circuit may be configured to generate and provide a first list of items included in the first of the historical transactions to the GUI of the user device in response to receiving a selection of the first actionable item from the user device. The processing circuit may also be configured to generate and provide a second list of items included in the second of the historical transactions to the GUI of the user device in response to receiving a selection of the second actionable item from the user device.

Furthermore, in some instances, the interactive elements associated with the historical transactions shown within the notification interface provided to the GUI may be arranged within the notification interface based on their estimated relevance to the user. For example, in some instances, the processing circuit is configured to estimate the most relevant and/or beneficial of the historical transactions for inclusion within the notification using one or more machine learning models of the processing circuit. In some instances, the processing circuit may train the one or more machine learning models to identify the most relevant and/or beneficial of the historical transactions for inclusion using various training data. The training data may include historical transaction data of users, and corresponding user information (e.g., income level, geographic location, transaction data, etc.) associated with those users. In some instances, the training data may be data compiled over time from a variety of users associated with the provider and stored within a database associated with the provider system 135.

Accordingly, once the one or more machine learning models have been trained, the processing circuit may apply the historical transaction data of users and various user information pertaining to the user to the one or more machine learning models to identify the most relevant and/or beneficial of the historical transactions for inclusion on the notification interface provided to the GUI of the user device. The processing circuit may further arrange the interactive elements indicating the historical transactions specifically according to their estimated relevance. For example, in some instances, the most relevant interactive elements may be arranged in a top left corner of the notification interface. The interactive elements may be arranged in descending order of relevance from left to right and top to bottom within the notification interface. In some instances, the processing circuit is configured to utilize various feedback information (e.g., additional transactions made by the person, etc.) received from the user (e.g., via the user device 140) to retrain or otherwise update the one or more machine learning models. Accordingly, in some instances, the processing circuit may rearrange the interactive elements on the notification interface based on the updated machine learning models and their associated outputs.

In some instances, the processing circuit is configured to provide the merchant match data corresponding to the merchant to the merchant. The merchant match data may be provided to the merchant so that the merchant may provide a service to the person associated with the merchant match data. For example, the merchant match data may be utilized by the merchant to prepare items that the person may want to purchase based on the historical transactions included in the merchant match data and the fact that the person is in proximity to the merchant. For example, if the historical transactions of the person with the merchant included in the merchant match data are associated with cookbooks, the merchant may prepare to display additional cookbooks to the person in response to the person being within the distance threshold of the merchant. As a result, the merchant may be better prepared to receive the person in response to the person being within the distance threshold of the merchant and the person may receive better service (e.g., more targeted service, personalized service, etc.) from the merchant. In some instances, the merchant match data is provided to a merchant computing system associated with the merchant. For example, a merchant may operate a merchant computing system configured to track historical transactions of people and to analyze merchant match data associated with the historical transactions of the people.

In some instances, the processing circuit is configured to receive offer data corresponding to offers relating to the merchant. For example, a merchant may analyze historical transactions of a person with the merchant and generate offers that target the person based on the historical transactions. The offers may be related to items included in the historical transactions. For example, an offer may correspond to a future transaction corresponding to an item included in one of the historical transactions or an offer may correspond to a second item that is related to a first item included in one of the historical transactions. In some instances, the processing circuit is configured to receive the offer data from a merchant computing system associated with the merchant. For example, a merchant computing system associated with a merchant may receive the merchant match data from the processing circuit, analyze the merchant match data to generate offers for the person associated with the merchant match data, and provide the offers to the processing circuit. As another example, a merchant computing system associated with a merchant may generate offers for a person based on historical transactions of the person with the merchant and may provide the offers to the processing circuit. In some instances, the merchant computing system may generate the offers without accessing the merchant match data.

In some instances, the processing circuit may generate and provide an offer interface corresponding to the offer data or the offers received from the merchant for the person to the user device. For example, the offer interface may include text describing the offers from the merchant, values associated with the offers, and/or images of items associated with the offers. In some instances, the offer interface may correspond to the offer data or the offers received from multiple of the merchants for the person. For example, the offer interface may include interactive elements corresponding to a first offer received from a first merchant and a second offer received from a second merchant. In some instances, the processing circuit may be configured to organize the offers in the offer interface based on a relevance to the person. For example, if a first offer from a first merchant is more relevant to the person than a second offer from a second merchant, the processing circuit may arrange the offer interface such that a first interactive element corresponding to the first offer is arranged above a second interactive element corresponding to the second offer.

In some instances, the processing circuit may model the offer data received from the merchant with the merchant match data to generate recommendation data. The recommendation data may correspond to at least one of the offers included in the offer data and to at least one of the historical transactions of the person. For example, the processing circuit may receive the offer data from the merchant and determine an offer included in the offer data to recommend to the person based on the historical transactions of the person. For example, if the offer data from the merchant includes a first offer for bread and a second offer for cans of soup and the historical transactions of the person include frequent transactions for bread, the processing circuit may include the first offer for the bread in the recommendation data since the person frequently purchases bread. As another example, if the offer data from the merchant includes a first offer for a grill and a second offer for grill implements and the historical transactions of the person include a recent transaction for a grill, the processing circuit may include the second offer for the grill implements in the recommendation data since the person had recently purchased the grill.

In some instances, the processing circuit may generate and provide a recommendation interface corresponding to the recommendation data to the user device. The recommendation data may correspond to at least one of the offers from the merchant relating to at least one of the historical transactions of the person. For example, the recommendation interface may include text describing recommendations of the offers from the merchants, text describing reasoning for the recommendations of the offers, images corresponding to the recommendations of the offers, or other information relating to the offers. For example, the recommendation interface may display the offers received from the merchant in a ranked order (e.g., descending order, etc.) based on the modeling of the offer data with the merchant match data.

In some instances, the processing circuit may generate and provide a transaction interface to the user device corresponding to additional transactions made by other people with the merchant corresponding to the merchant match data. For example, the transaction interface may display a first transaction with the merchant made by a first person, a second transaction with the merchant made by a second person, and a third transaction with the merchant made by a third person. The additional transactions made by the other people may assist the user of the user device with planning transactions with the merchant. For example, if the transaction interface includes interactive elements relating to several transactions with the merchant for cell phones, the user of the user device may plan a future transaction with the merchant for a cell phone. In some instances, the transaction interface includes interactive elements related to the additional transactions made by the other people who are similar (e.g., similarly situated, etc.) to the person associated with the merchant match data. For example, the other people who are similar may spend an average amount at the merchant associated with the merchant match data as the person, may visit the merchant with a similar frequency as the person, may have similar historical transactions as the historical transactions of the person, etc.

In various instances, the processing circuit may be configured to initiate transactions of the user of the user device with the merchant through the transaction interface. For example, the user of the user device may initiate a transaction with the merchant for an item through the transaction interface by selecting an actionable item interactive element associated with the item. The transaction interface may include actionable interactive elements associated with items that allow the processing circuit to initiate transactions for the items associated with the actionable interactive elements after receiving a selection of the actionable interactive elements from the user of the user device.

Referring now to FIG. 4, an illustration of a configuration of a user interface 400 on the user device 140 is shown. The user interface 400 may be presented within the user client application 154. In some embodiments, the user interface 400 is generated and provided by the content control circuit 128 and transmitted to the user device 140 to be displayed to a user.

As illustrated, the user interface 400 includes a notification interface 402, a merchant interactive element 404, a plurality of transaction interactive elements 406, and a plurality of transaction actionable items 408, each associated with one of the transaction interactive elements 406. The notification interface 402 may be configured to provide a notification to a user of the user device 140. As illustrated, the notification interface 402 is a popup window that is configured to overlay on top of other interactive elements of the user interface 400 of the user device 140. In other instances, the notification interface 402 may be a drop down menu, a banner, a lock screen notification, a badge icon, a floating notification, or another type of notification on the user interface 400 of the user device 140. In some instances, the notification interface 402 may be part of an application of the user device 140. The notification interface 402 may include information relating to a merchant match analysis.

The merchant interactive element 404 may indicate the merchant that corresponds to the merchant match data generated as part of a merchant match analysis. As illustrated, the merchant interactive element 404 is a text prompt indicating the merchant that corresponds to the merchant match data generated as part of the merchant match analysis. In some instances, the merchant interactive element 404 may include figures indicating the merchant (e.g., a logo of the merchant, an image of a storefront of the merchant, etc.), interactive elements indicating a merchant location of the merchant, etc. For example, if the merchant match data corresponds to a grocery store, the merchant interactive element 404 may include a name of the grocery store, a logo of the grocery store, and/or an address of the grocery store.

The transaction interactive elements 406 are interactive elements that indicate historical transactions of a person that are related to the merchant corresponding to the merchant match data. In some instances, the transaction interactive elements 406 may be associated with the historical transactions included in the transaction data received in step 304, discussed above. As illustrated, the transaction interactive elements 406 may include text detailing the historical transactions, descriptions of the historical transactions lists of items included in the historical transactions, figures relating to the historical transactions, photographs of the historical transactions, videos of the historical transactions, dates that the historical transactions occurred, etc. As illustrated, a first of the transaction interactive elements 406 may relate to a first of the historical transactions related to the merchant of the merchant interactive element 404 and a second of the of the transaction interactive elements 406 may relate to a second of the historical transactions related to the merchant of the merchant interactive element 404. In various instances, the transaction interactive elements 406 may indicate each of the historical transactions of the person that are related to the merchant corresponding to the merchant match data. In some instances, the user of the user device 140 may scroll through a list of the transaction interactive elements 406 to view all of the transaction interactive elements 406 indicating each of the historical transactions of the person that are related to the merchant corresponding to the merchant match data.

The transaction actionable items 408 (e.g., actionable button, interactable button, etc.) may influence an actionable activity. The transaction actionable items 408 may be associated with the historical transactions associated with the transaction interactive elements 406. In some instances, the user may select one of the transaction actionable items 408 to receive additional information related to the historical transactions. For example, in some instance, the selection of the transaction actionable item 408 may allow for the processing circuit to generate and provide a list of items included in the historical transaction, an amount associated with the historical transaction, a date associated with the historical transaction, complete a transaction that corresponds with the historical transaction with the merchant (e.g., initiate a repeat transaction with the merchant that includes the same items as the historical transaction, etc.), or take other actions based on the historical transaction associated with the transaction interactive elements 406.

Referring now to FIG. 5, an illustration of a configuration of the user interface 400 on the user device 140 is shown. As illustrated, the user interface 400 includes a detail interface 410, a transaction title interactive element 412, and item interactive elements 414. The detail interface 410 be configured to provide additional information related to one of the historical transactions associated with the transaction interactive elements 406. In some instances, the detail interface 410 may be generated and provided by the processing circuit in response to the user selecting one of the transaction actionable items 408 associated with the transaction interactive elements 406.

The transaction title interactive element 412 indicates the one of the historical transactions that is included in the detail interface 410. The transaction title interactive element 412 may include similar interactive elements to the transaction interactive elements 406. For example, the transaction title interactive element may include text detailing the one of the historical transactions, a description corresponding to the one of the historical transactions, figures associated with the one of the historical transactions, etc.

The item interactive elements 414 indicate each item included in the one of the historical transactions indicated by the transaction title interactive element 412. As illustrated, the item interactive elements 414 may include text related to the items, dates that the historical transaction for the items occurred, the merchant associated with the historical transaction for the items, an amount that was exchanged for the item, etc. For example, one of the item interactive elements 414 associated with a television included in a historical transaction may include the text “36 IN. Flatscreen Television”, an image of the television, an amount that was exchanged for the television in the historical transaction, a date of the historical transaction that included the television, etc. . . . In some instances, the detail interface 410 may include one of the item interactive elements 414 for each of the items included in the historical transaction associated with the transaction title interactive element 412.

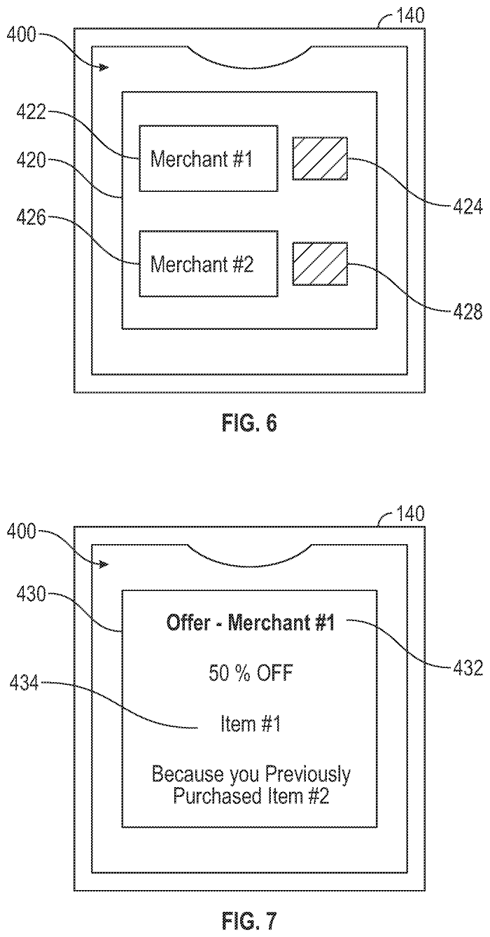

Referring now to FIG. 6, an illustration of a configuration of the user interface 400 on the user device 140 is shown. As illustrated, the user interface 400 includes a multiple merchant interface 420, a first merchant interactive element 422, a first merchant actionable item 424, a second merchant interactive element 426, and a second merchant actionable item 428. The multiple merchant interface 420 may indicate multiple of the merchants that correspond with the merchant match data. For example, the multiple merchant interface 420 may indicate that the merchant match data corresponds with a first merchant within a threshold distance of the location included in the location data and corresponds with a second merchant within the threshold distance of the location included in the location data. In various instances, the multiple merchant interface 420 may include additional of the merchants that correspond with the merchant match data (e.g., three of the merchants, four of the merchants, etc.).

The first merchant interactive element 422 may be an indication that indicates a first merchant that corresponds with the merchant match data and the second merchant interactive element 426 may be an indication that indicates a second merchant corresponds with the merchant match data. The first merchant interactive element 422 and the second merchant interactive element 426 may include information corresponding to the first merchant and the second merchant respectively, similar to the merchant interactive element 404. For example, the first merchant interactive element 422 may include a name and a logo of the first merchant and the second merchant interactive element 426 may include a name and a logo of the second merchant. In some instance, the first merchant interactive element 422 and the second merchant interactive element 426 may include information associated with the historical transactions of the person relating to the first merchant and the second merchant respectively. For example, the first merchant interactive element 422 and the second merchant interactive element 426 may include a number of the historical transactions related to the respective merchants, a total amount of the historical transactions related to the respective merchants, or other information that allow for the user to compare the historical transactions related to the first merchant with the historical transactions associated with the second merchant. In various instances, the multiple merchant interface 420 may include additional merchant interactive elements associated with additional merchants within the threshold distance of the location included in the location data (e.g., a third merchant interactive element, a fourth merchant interactive element, etc.).

The first merchant actionable item 424 (e.g., actionable button, interactable button, etc.) may be associated with the first merchant associated with the first merchant interactive element 422 and the second merchant actionable item 428 (e.g., actionable button, interactable button, etc.) may be associated with the second merchant associated with the second merchant interactive element 426. The first merchant actionable item 424 and the second merchant actionable item 428 may influence an actionable activity. In some instances, the user may select one of the first merchant actionable item 424 or the second merchant actionable item 428 to receive additional information related to the historical transactions related to the first merchant or the second merchant respectively. For example, in some instances, the selection of the first merchant actionable item 424 may allow for the processing circuit to generate and provide the notification interface 402 corresponding to the first merchant and the selection of the second merchant actionable item 428 may allow for the processing circuit to generate and provide the notification interface corresponding to the second merchant. In various instances, the multiple merchant interface 420 may include additional actionable interactive elements associated with the additional merchant interactive elements (e.g., a third merchant actionable item, a fourth merchant actionable item, etc.).

Referring now to FIG. 7, an illustration of a configuration of the user interface 400 on the user device 140 is shown. As illustrated, the user interface 400 includes an offer interface 430, a merchant interactive element 432, and an offer interactive element 434. The offer interface 430 may indicate offers related to transactions with the merchants that correspond to the merchant match data. For example, the offer interface 430 may indicate a sale associated with one of the items offered by the merchant that corresponds with the merchant match data. In some instances, the offer indicated by the offer interface 430 may be personalized for the user of the user device. For example, the offer may be provided to the processing circuit by the merchant based on the transaction data of the person (e.g., the historical transactions of the person, etc.).

The merchant interactive element 432 may be an indication that indicates that a merchant that corresponds with the merchant match data is offering an offer to the user of the user device. The merchant interactive element 432 may include information corresponding to the merchant that is offering the offer, similar to the merchant interactive element 404. For example, the merchant interactive element 432 may include a name of the merchant and an address of the merchant.

The offer interactive element 434 indicates the offer that the merchant is offering to the user of the user device. As illustrated, the offer interactive element 434 may include text related to the offer, a figure of the item associated with the offer, etc. For example, the offer interactive element 434 may include a discount amount (e.g., 50% off, etc.) associated with the offer and the item (e.g., item #1, etc.) that is associated with the offer. In some instances, the offer interactive element 434 may include a coupon associated with the offer. For example, the offer interactive element 434 may include a barcode or a QR code associated with the offer that must be scanned by the merchant in order for the user of the user device to redeem the offer. In some instances, the offer interactive element 434 may also indicate a reason that the user of the user device is receiving the offer associated with the offer interactive element 434. As illustrated, the offer interactive element 434 may include text explaining why the user of the user device is receiving the offer, an image depicting a relationship between the historical transactions of the person and the offer, etc. For example, the offer interactive element 434 may indicate that the user of the user device is receiving an offer for a first item because the user previously purchased a second item during one of the historical transactions of the user and that the first item is related to the second item.

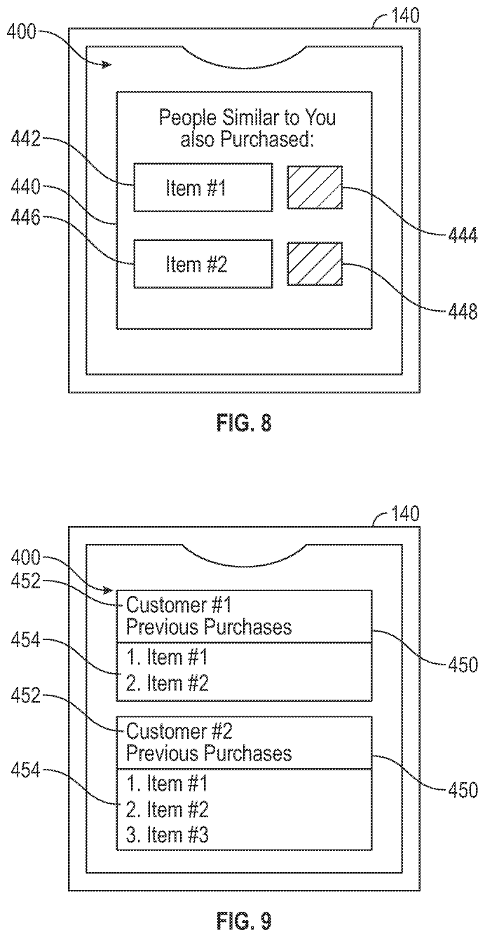

Referring now to FIG. 8, an illustration of a configuration of the user interface 400 on the user device 140 is shown. As illustrated, the user interface 400 includes a transaction interface 440, a first item interactive element 442, a first item actionable item 444, a second item interactive element 446, and a second item actionable item 448. The transaction interface 440 may indicate potential transactions with the merchant that corresponds to the merchant match data. For example, the transaction interface 440 may indicate items that the merchant has available for purchase. In some embodiments, the potential transactions included in the transaction interface 440 are displayed based on historical transactions made by other people. In some instances, the transaction interface 440 may indicate a reason why the items included in the transaction interface 440 are being displayed to the user of the user device. For example, the other people making the historical transactions may be similar to the user of the user device (e.g., belong to the same economic class, live in the same area, purchase the same items, etc.) As illustrated, the transaction interface 440 includes text related to the reason why the items included in the transaction interface 440 are being displayed to the user of the user device. For example, the transaction interface 440 may include text stating that the items included in the transaction interface 440 were purchased by people similar to the user of the user device.

The first item interactive element 442 may indicate a first item that may be included in a potential transaction with the merchant that corresponds to the merchant match data. The second item interactive element 446 may indicated a second item that may be included in the potential transaction with the merchant that corresponds to the merchant match data. In some instances, the first item and the second item may be offerings from the merchant to the user of the user device. For example, the user of the user device may purchase the first item or the second item from the merchant. As illustrated, the first item interactive element 442 and the second item interactive element 446 may include text related to the items, other information related to the items similar to the item interactive elements 414, etc.

The first item actionable item 444 (e.g., actionable button, interactable button, etc.) may be associated with the first item associated with the first item interactive element 442 and the second item actionable item 448 (e.g., actionable button, interactable button, etc.) may be associated with the second item associated with the second item interactive element 446. The first item actionable item 444 and the second item actionable item 448 may influence actionable activities, In some instances, the user may select one of the first item actionable item 444 or the second item actionable item 448 to initiate a transaction with the merchant that includes the first item associated with the first item interactive element 442 or the second item associated with the second item interactive element 446 respectively. For example, in some instances, the selection of the first item actionable item 444 associated with the first item interactive element 442 associated with a computer may initiate a transaction between the user of the user device and the merchant for the computer.

Referring now to FIG. 9, an illustration of a configuration of the user interface 400 on the user device 140 is shown. As illustrated, the user interface 400 includes a plurality of tracker interfaces 450, a plurality of customer interactive elements 452, and a plurality of list interactive elements 454. The tracker interfaces 450 may indicate historical transactions that have occurred between the merchant and unique customers. For example, a first of the tracker interfaces 450 may indicate historical transactions that have occurred between the merchant and a first customer and a second of the tracker interfaces 450 may indicate historical transactions that have occurred between the merchant and a second customer. In this way, the merchant may track which of the historical transactions occurred between each of the customers of the merchant and the merchant. The processing circuit may be configured to generate the tracker interfaces 450 based on the transaction data associated with customers who have made historical transactions with the merchant. In some instances, the processing circuit is configured to generate the tracker interface 450 and provide the tracker interface 450 to the merchant when a location associated with the person associated with the tracker interface 450 is within the distance threshold of the merchant. For example, the processing circuit may generate and provide the tracker interface 450 associated with a first person to the merchant when a location of the first person is within the distance threshold of the merchant.

The customer interactive elements 452 indicate customers that have made historical transactions with the merchant. As illustrated, the customer interactive elements 452 may include text related to the customers, images related to the customers, descriptions related to the customers, etc. For example, each of the customer interactive elements 452 may include a name of a customer, a photograph of the customer, and a brief description relating to an appearance of the customer. In this way, the customer interactive elements 452 may be utilized by the merchant to identify each of the customers.

The list interactive elements 454 indicate items included in the historical transactions made between the customers associated with the customer interactive elements 452 and the merchant. As illustrated, the list interactive elements 454 may include text related to each of the items, images related to each of the items, descriptions related to each of the items, etc. In some instances, the list interactive elements 454 include similar interactive elements to the item interactive elements 414.

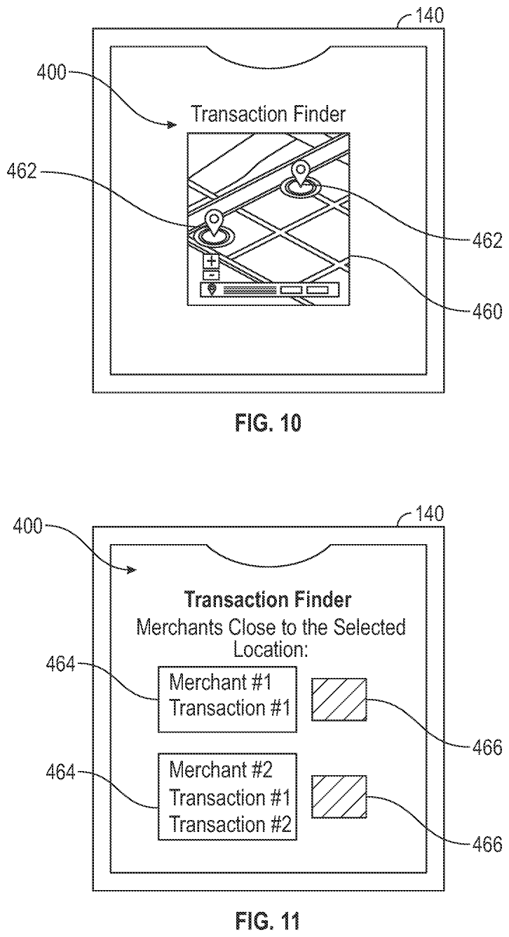

Referring now to FIG. 10, an illustration of a configuration of the user interface 400 on the user device 140 is shown. As illustrated, the user interface 400 includes a location interface 460 and a plurality of location interactive elements 462. As illustrated, the location interface 460 may be an interface that allows for the user of the user device to select a location for use in the merchant match analysis. For example, the location interface 460 may be an image of a map and the user may select a point (e.g., drop a pin, etc.) on the map to determine the location for use in the merchant match analysis. In various instances, the location interface 460 includes text related to merchants whose merchant locations are displayed in the location interface 460. In various instances, the user of the user device may modify a boundary of the location interface 460 such that the location interface 460 displays additional locations.

The location interface 460 may include the location interactive elements 462. The location interactive elements 462 may represent potential locations displayed on the location interface 460. For example, the location interactive elements 462 may represent roads, buildings, intersections, businesses, etc. The user may select one of the location interactive elements 462 in order to select a location corresponding with the potential location of the location interactive element 462 for use in the merchant match analysis.

Referring now to FIG. 11, an illustration of a configuration of the user interface 400 on the user device 140 is shown. As illustrated, the user interface 400 includes a plurality of merchant interactive elements 464 and a plurality of merchant actionable interactive elements 466. The merchant interactive elements 464 may include merchants that correspond with the merchant match data based on the location interactive element 462 selected by the user in the location interface 460. For example, the location associated with the location interactive element 462 selected by the user may include multiple merchants within the distance threshold of the location that are related to historical transactions of the user. As illustrated, the merchant interactive elements 464 may include information associated with the merchants similar to the merchant interactive element 404.

The merchant actionable interactive elements 466 (e.g., actionable buttons, interactable buttons, etc.) may each be associated with one of the merchant interactive elements 464. The merchant actionable interactive elements 466 may influence an actionable activity. In some instances, the user may select one of the merchant actionable interactive elements 466 to display the historical transactions that relate to the merchant associated with the merchant interactive element 464 associated with the merchant actionable interactive elements 466. For example, in some instances, the selection of the merchant actionable interactive elements 466 may cause the user interface 400 to display the notification interface 402 that corresponds with the merchant associated with the merchant interactive element 464 associated with the merchant actionable interactive elements 466.

It should be understood that no claim element herein is to be construed under the provisions of 35 U.S.C. § 112(f) unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory).

Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. A system comprising:
a processing circuit comprising memory and one or more processors, the processing circuit configured to:
generate location data relating to a person associated with transaction data, the location data associated with a location;
receive the transaction data relating to the person, wherein the transaction data corresponds to historical transactions of the person;
generate merchant match data based on the location data and the transaction data, wherein the merchant match data indicates a merchant within a distance threshold of the location and being associated with at least one of the historical transactions; and
generate and provide, to a graphical user interface (GUI) of a user device, a notification interface based on the merchant match data, wherein the notification interface comprises an interactive element associated with the at least one of the historical transactions related to the merchant.

2. The system of claim 1, wherein the interactive element comprises a list of items included in one of the historical transactions related to the merchant.

3. The system of claim 1, wherein the notification interface further comprises an actionable item associated with one of the historical transactions; and
wherein in response to receiving a selection of the actionable item from the user device, the processing circuit is further configured to:
generate and provide, to the GUI of the user device, a list of items included in the one of the historical transactions.

4. The system of claim 1, wherein the processing circuit is configured to be triggered to generate the location data responsive to determining that the user device is positioned within the distance threshold of the merchant.

5. The system of claim 4, wherein the merchant is a first merchant, the at least one of the historical transactions is a first of the historical transactions, and the interactive element is a first interactive element;
wherein the merchant match data further indicates a second merchant within the distance threshold of the location and being associated with a second of the historical transactions;
wherein the notification interface further comprises a second interactive element associated with the second of the historical transactions, a first actionable item associated with the first of the historical transactions, and a second actionable item associated with the second of the historical transactions;
wherein in response to receiving a selection of the first actionable item from the user device, the processing circuit is further configured to:
generate and provide, to the GUI of the user device, a first list of items included in the first of the historical transactions; and
wherein in response to receiving a selection of the second actionable item from the user device, the processing circuit is further configured to:
generate and provide, to the GUI of the user device, a second list of items included in the second of the historical transactions.

6. The system of claim 1, wherein prior to generating the location data, the processing circuit is configured to provide, to the GUI of the user device, a location interface comprising a plurality of location interactive elements, wherein each of the location interactive elements corresponds to a respective potential location; and
wherein in response to receiving a selection of one of the location interactive elements from the user device, the processing circuit is further configured to:
generate the location data, wherein the location based on the location data is one of the potential locations corresponding to the one of the location interactive elements.

7. The system of claim 6, wherein the merchant is a first merchant, the at least one of the historical transactions is a first of the historical transactions, and the interactive element is a first interactive element;
wherein the merchant match data further indicates a second merchant within the distance threshold of the location and being associated with a second of the historical transactions;
wherein the notification interface further comprises a second interactive element associated with the second of the historical transactions, a first actionable item associated with the first of the historical transactions, and a second actionable item associated with the second of the historical transactions;
wherein in response to receiving a selection of the first actionable item from the user device, the processing circuit is further configured to:
generate and provide, to the GUI of the user device, a first list of items included in the first of the historical transactions; and
wherein in response to receiving a selection of the second actionable item from the user device, the processing circuit is further configured to:
generate and provide, to the GUI of the user device, a second list of items included in the second of the historical transactions.

8. The system of claim 1, wherein the processing circuit is further configured to:
provide, to a merchant computing system associated with the merchant, the merchant match data indicative of the merchant;
receive, from the merchant computing system, an offer associated with the person, the offer relating to the at least one of the historical transactions related to the merchant; and
generate and provide, to the GUI of the user device, an offer interface corresponding to the offer.

9. The system of claim 1, wherein the processing circuit is further configured to:
receive, from a merchant computing system associated with the merchant, offer data corresponding to offers relating to the merchant;
generate recommendation data corresponding to at least one of the offers relating to the at least one of the historical transactions; and
generate and provide, to the GUI of the user device, a recommendation interface corresponding to the at least one of the offers.

10. A method comprising:
generating, by a processing circuit, location data relating to a person associated with transaction data, the location data associated with a location;
receiving the transaction data relating to the person, wherein the transaction data corresponds to historical transactions of the person;
generating merchant match data based on the location data and the transaction data, wherein the merchant match data indicates a merchant within a distance threshold of the location and being associated with at least one of the historical transactions; and
generating and providing, to a graphical user interface (GUI) of a user device, a notification interface based on the merchant match data, wherein the notification interface comprises an interactive element associated with the at least one of the historical transactions related to the merchant.

11. The method of claim 10, wherein the interactive element comprises a list of items included in one of the historical transactions related to the merchant.

12. The method of claim 10, wherein the notification interface further comprises an actionable item associated with one of the historical transactions, and the method further comprises:
receiving a selection of the actionable item from the user device; and
generating and providing, to the GUI of the user device, a list of items included in the one of the historical transactions.

13. The method of claim 10, further comprising:
generating the location data based on a trigger responsive to determining that the user device is positioned within the distance threshold of the merchant.

14. The method of claim 13, wherein the merchant is a first merchant, the at least one of the historical transactions is a first of the historical transactions, and the interactive element is a first interactive element;
wherein the merchant match data further indicates to a second merchant within the distance threshold of the location and being associated with a second of the historical transactions;
wherein the notification interface further comprises a second interactive element associated with the second of the historical transactions, a first actionable item associated with the first of the historical transactions, and a second actionable item associated with the second of the historical transactions; and
wherein the method further comprises:
responsive to receiving a selection of the first actionable item from the user device, generating and providing, to the GUI of the user device, a first list of items included in the first of the historical transactions; and
responsive to receiving a selection of the second actionable item from the user device, generating and providing, to the GUI of the user device, a second list of items included in the second of the historical transactions.

15. The method of claim 10, wherein prior to generating the location data, the method further comprises:
providing, to the GUI of the user device, a location interface comprising a plurality of location interactive elements, wherein each of the location interactive elements corresponds to a respective potential location;
wherein in response to receiving a selection of one of the location interactive elements from the user device, the method further comprises:
generating the location data, wherein the location based on the location data is one of the potential locations corresponding to the one of the location interactive elements.

16. The method of claim 10, further comprising:
providing, to a merchant computing system associated with the merchant, the merchant match data indicative of the merchant;
receiving, from the merchant computing system, an offer associated with the person, the offer relating to the at least one of the historical transactions related to the merchant; and
generating and providing, to the GUI of the user device, an offer interface corresponding to the offer.

17. The method of claim 10, further comprising:
receiving, from a merchant computing system associated with the merchant, offer data corresponding to offers relating to the merchant;
generate recommendation data corresponding to at least one of the offers relating to the at least one of the historical transactions; and
generating and providing, to the GUI of the user device, a recommendation interface corresponding to the at least one of the offers.

18. A non-transitory computer-readable storage medium having instructions stored thereon that, when executed by one or more processing circuits, cause the one or more processing circuits to perform operations comprising:
generating, by the one or more processing circuits, location data relating to a person associated with transaction data, the location data associated with a location;
receiving the transaction data relating to the person, wherein the transaction data corresponds to historical transactions of the person;
generating merchant match data based on the location data and the transaction data, wherein the merchant match data indicates a merchant within a distance threshold of the location and being associated with at least one of the historical transactions; and
generating and providing, to a graphical user interface (GUI) of a user device, a notification interface based on the merchant match data, wherein the notification interface comprises an interactive element associated with the at least one of the historical transactions related to the merchant.

19. The non-transitory computer-readable storage medium of claim 18, wherein the notification interface further comprises an actionable item associated with one of the historical transactions; and
wherein the operations further comprise:
receiving a selection of the actionable item from the user device; and
generating and providing, to the GUI of the user device, a list of items included in the one of the historical transactions.

20. The non-transitory computer-readable storage medium of claim 18, wherein the operations further comprise:
providing, to a merchant computing system associated with the merchant, the merchant match data indicative of the merchant;
receiving, from the merchant computing system, an offer associated with the person, the offer relating to the at least one of the historical transactions related to the merchant; and
generating and providing, to the GUI of the user device, an offer interface corresponding to the offer.
